(19) United States
(12) Patent Application Publication
(10) Pub. No.: US 2021/0179944 A1
(43) Pub. Date: Jun. 17, 2021

(54) LIQUID CRYSTAL MATERIAL, LIQUID CRYSTAL DISPLAY PANEL, AND DISPLAY DEVICE

(71) Applicant: TCL CHINA STAR OPTOELECTRONICS TECHNOLOGY CO., LTD., Shenzhen (CN)

(72) Inventor: Dong LIAO, Shenzhen (CN)

(73) Assignee: TCL CHINA STAR OPTOELECTRONICS TECHNOLOGY CO., LTD., Shenzhen (CN)

(21) Appl. No.: 16/627,314

(22) PCT Filed: Dec. 27, 2019
(86) PCT No.: PCT/CN2019/129200

§ 371 Date: Dec. 29, 2019

(30) Foreign Application Priority Data
Dec. 17, 2019 (CN) 201911298178.8

(51) Int. Cl. C09K 19/56; G02F 1/1335

(52) U.S. Cl. CPC C09K 19/56; C09K 2019/0448; G02F 1/133514

(57) ABSTRACT

The present application proposes a liquid crystal material and a liquid crystal display panel. The liquid crystal material includes liquid crystal molecules and at least two types of polymerizable monomers; wherein each of the polymerizable monomers has a structural formula including at least one P group, at least one Z group, and at least one X group, the P group is located on opposite sides of each of the polymerizable monomers, and at least one side of the Z group is connected to the X group.

### BACKGROUND OF INVENTION

### Field of Invention

The present application relates to a field of display, and particularly to a liquid crystal material, a liquid crystal display panel, and a display device.

### Description of Prior Art

With the development of display technology, flat display devices such as liquid crystal displays (LCD) and the like, have been widely used and become mainstream in display devices due to their advantages of high picture quality, power saving, thin body, wide range of applications, and so on.

A liquid crystal layer is often provided between a color filter substrate and an array substrate of the liquid crystal display, and the liquid crystal layer includes liquid crystal molecules and polymerizable monomers. In the prior art, in order to improve the alignment ability of liquid crystal molecules, the liquid crystal layer generally includes a plurality of types of polymerizable monomers. However, polymerization rates and deflection angles of different polymerizable monomers are different, resulting in difference in pretilt angles formed by different polymerizable monomers, which causes uneven spots on the panel and impacts the product quality.

Therefore, there is an urgent need to develop a liquid crystal material to solve the above technical problems.

### SUMMARY OF INVENTION

The present application provides a display device, a manufacturing method thereof, and a display device to solve the technical problems of low color gamut and low backlight conversion efficiency of existing light-emitting diodes.

The present application provides a liquid crystal material, including liquid crystal molecules and at least two types of polymerizable monomers;

wherein each of the polymerizable monomers has a structural formula including at least one P group, at least one Z group, and at least one X group, the P group is located on opposite sides of each of the polymerizable monomers, and at least one side of the Z group is connected to the X group.

In the liquid crystal material of the present application, the polymerizable monomers include at least a first-type polymerizable monomer, a second-type polymerizable monomer, and a third-type polymerizable monomer;

the first-type polymerizable monomer has a structural formula of:

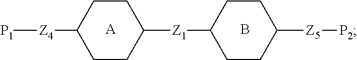

the second-type of polymerizable monomer has a structural formula of:

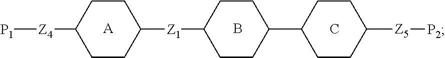

and

the third-type of polymerizable monomer has a structural formula of:

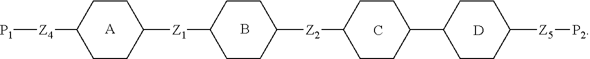

In the liquid crystal material of the present application, the P1 group and the P2 group are the P group, and each of the P1 group and the P2 group is selected from one of methacrylate, acrylate, vinyl, vinyloxy, and epoxy;

the Z1 group, the Z2 group, the Z4 group, and the Z5 group are the Z group, the Z1 group, the Z2 group, the Z4 group, and the Z5 group are —(CH2)n- groups, or —(CH2)n- groups including one or more of the —CH2- substituted by one or more of —O—, —S—, —CO—, —CO—O—, —O—CO—, —O—CO—O—, —OCH2-, —CH2O—, —CH═CH—, —CF═CF—, —C≡C—, —CH═CH—COO—, and —OCO—CH═CH—; and

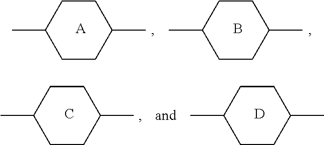

are the X group, and each of the

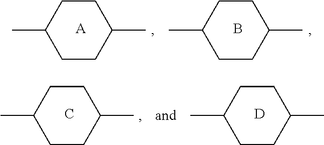

are one of phenyl, phenyl including one or more of hydrogen atoms substituted by F, Cl, Br, I, —CN, —NO2, or —C(═O)H, and cycloalkyl.

In the liquid crystal material of the present application, the X group is one of 1,4-phenylene, 2,6-phenylene, and 1,4-cyclohexylene.

In the liquid crystal material of the present application, one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and

the main polymerization monomer is present in the liquid crystal material in a mass fraction of 0.2% to 1%, and the branching polymerization monomers are present in the liquid crystal material in a mass fraction of 0.03% to 0.05%.

The present application also proposes a liquid crystal display panel including a color filter substrate, an array substrate, and a liquid crystal layer disposed between the color filter substrate and the array substrate, wherein

the liquid crystal layer includes liquid crystal molecules and at least two types of polymerizable monomers; and

each of the polymerizable monomers has a structural formula including at least one P group, at least one Z group, and at least one X group, the P group is located on opposite sides of each of the polymerizable monomers, and at least one side of the Z group is connected to the X group.

In the liquid crystal display panel of the present application, the polymerizable monomers include at least a first-type polymerizable monomer, a second-type polymerizable monomer, and a third-type polymerizable monomer;

the first-type polymerizable monomer has a structural formula of:

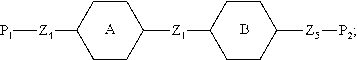

the second-type of polymerizable monomer has a structural formula of:

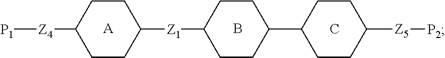

and

the third-type of polymerizable monomer has a structural formula of:

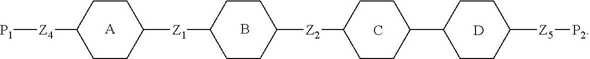

In the liquid crystal display panel of the present application, the P1 group and the P2 group are the P group, and each of the P1 group and the P2 group is selected from one of methacrylate, acrylate, vinyl, vinyloxy, and epoxy;

the Z1 group, the Z2 group, the Z4 group, and the Z5 group are the Z group, the Z1 group, the Z2 group, the Z4 group, and the Z5 group are —(CH2)n- groups, or —(CH2)n- groups including one or more of the —CH2- substituted by one or more of —O—, —S—, —CO—, —CO—O—, —O—CO—, —O—CO—O—, —OCH2-, —CH2O—, —CH═CH—, —CF═CF—, —C≡C—, —CH═CH—COO—, and —OCO—CH═CH—; and

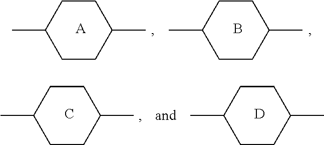

are the X group, and each of the

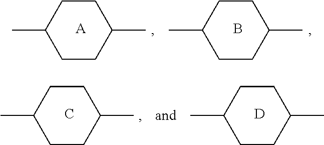

are one of phenyl, phenyl including one or more of hydrogen atoms substituted by F, Cl, Br, I, —CN, —NO2, or —C(═O)H, and cycloalkyl.

In the liquid crystal display panel of the present application, one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and

the main polymerization monomer is present in the liquid crystal material in a mass fraction of 0.2% to 1%, and the branching polymerization monomers are present in the liquid crystal material in a mass fraction of 0.03% to 0.05%.

In the liquid crystal display panel of the present application, a distance between the color filter substrate and the array substrate is 3.2 μm to 3.5 μm.

In the liquid crystal display panel of the present application, the X group is one of 1,4-phenylene, 2,6-phenylene, and 1,4-cyclohexylene.

The present application also provides a display device, including a backlight module and a liquid crystal display panel located on the backlight module, wherein the liquid crystal display panel includes a color filter substrate, an array substrate, and a liquid crystal layer disposed between a color filter substrate and the array substrate;

the liquid crystal layer includes liquid crystal molecules and at least two types of polymerizable monomers; and

each of the polymerizable monomers has a structural formula including at least one P group, at least one Z group, and at least one X group, the P group is located on opposite sides of each of the polymerizable monomers, and at least one side of the Z group is connected to the X group.

In the display device of the present application, the polymerizable monomers include at least a first-type polymerizable monomer, a second-type polymerizable monomer, and a third-type polymerizable monomer;

the first-type polymerizable monomer has a structural formula of:

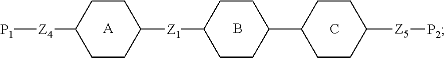

the second-type of polymerizable monomer has a structural formula of:

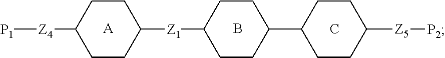

and

the third-type of polymerizable monomer has a structural formula of:

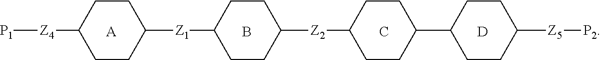

In the display device of the present application, the P1 group and the P2 group are the P group, and each of the P1 group and the P2 group is selected from one of methacrylate, acrylate, vinyl, vinyloxy, and epoxy;

the Z1 group, the Z2 group, the Z4 group, and the Z5 group are the Z group, the Z1 group, the Z2 group, the Z4 group, and the Z5 group are —(CH2)n- groups, or —(CH2)n- groups including one or more of the —CH2- substituted by one or more of —O—, —S—, —CO—, —CO—O—, —O—CO—, —O—CO—O—, —OCH2-, —CH2O—, —CH═CH—, —CF═CF—, —C≡C—, —CH═CH—COO—, and —OCO—CH═CH—; and

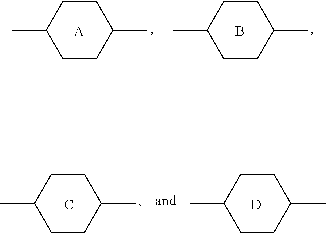

are the X group, and each of the

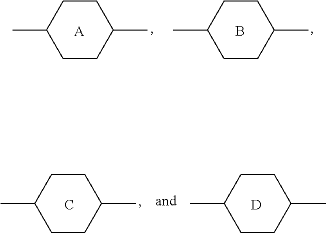

are one of phenyl, phenyl including one or more of hydrogen atoms substituted by F, Cl, Br, I, —CN, —NO2, or —C(═O)H, and cycloalkyl.

In the display device of the present application, one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and

the main polymerization monomer is present in the liquid crystal material in a mass fraction of 0.2% to 1%, and the branching polymerization monomers are present in the liquid crystal material in a mass fraction of 0.03% to 0.05%.

In the display device of the present application, a distance between the color filter substrate and the array substrate is 3.2 μm to 3.5 μm.

In the display device of the present application,

the X group is one of 1,4-phenylene, 2,6-phenylene, and 1,4-cyclohexylene.

The present application adopts at least two types of polymerizable monomers with different structural formulas, one type of the polymerizable monomers is a main polymerizable monomer, and the remaining polymerizable monomers are branching polymerization monomers, so that various types of polymerizable monomers in the present application have polymerization rates at different temperatures and pretilt angles for deflection which are within tolerance, thereby improving the display effect of the product.

### BRIEF DESCRIPTION OF DRAWINGS

FIG. 1 is a structural diagram of a liquid crystal display device of the present application.

### DETAILED DESCRIPTION OF PREFERRED EMBODIMENTS

In order to make the purpose, technical solution, and effect of the present application clearer, the present application is further described in detail below with reference to the accompanying drawings and examples. It should be understood that the specific embodiments described herein are only used to explain the present application, and are not used to limit the present application.

A liquid crystal layer is often provided between a color filter substrate and an array substrate of the liquid crystal display, and the liquid crystal layer includes liquid crystal molecules and polymerizable monomers. In the prior art, in order to improve the alignment ability of liquid crystal molecules, the liquid crystal layer generally includes a plurality of types of polymerizable monomers. However, polymerization rates and deflection angles of different polymerizable monomers are different, resulting in difference in pretilt angles formed by different polymerizable monomers, which causes uneven spots on the panel and impacts the product quality.

Accordingly, the present application proposes a liquid crystal material in view of the above technical problems.

The liquid crystal material includes liquid crystal molecules and at least two types of polymerizable monomers;

In this embodiment, each of the polymerizable monomers has a structural formula including at least one P group, at least one Z group, and at least one X group, the P group is located on opposite sides of each of the polymerizable monomers, and at least one side of the Z group is connected to the X group.

The present application adopts at least two types of polymerizable monomers with different structural formulas, one type of the polymerizable monomers is a main polymerizable monomer, and the remaining polymerizable monomers are branching polymerization monomers, so that various types of polymerizable monomers in the present application have polymerization rates at different temperatures and pretilt angles for deflection which are within tolerance, thereby improving the display effect of the product.

The technical solution of the present application will be described below according to specific embodiments.

The polymerizable monomers include at least a first-type polymerizable monomer, a second-type polymerizable monomer, and a third-type polymerizable monomer.

In this embodiment, the first-type polymerizable monomer has a structural formula of:

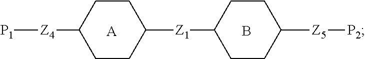

the second-type of polymerizable monomer has a structural formula of:

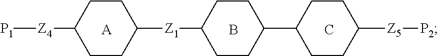

and

the third-type of polymerizable monomer has a structural formula of:

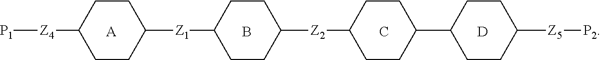

In this embodiment, the P1 group and the P2 group are the P group.

Each of the P1 group and the P2 group is selected from one of methacrylate, acrylate, vinyl, vinyloxy, and epoxy.

In this embodiment, the Z1 group, the Z2 group, the Z4 group, and the Z5 group are the Z group, the Z1 group, the Z2 group, the Z4 group, and the Z5 group are —(CH2)n- groups, or —(CH2)n- groups including one or more of the —CH2- substituted by one or more of —O—, —S—, —CO—, —CO—O—, —O—CO—, —O—CO—O—, —OCH2-, —CH2O—, —CH═CH—, —CF═CF—, —C≡C—, —CH═CH—COO—, and —OCO—CH═CH—.

In this embodiment,

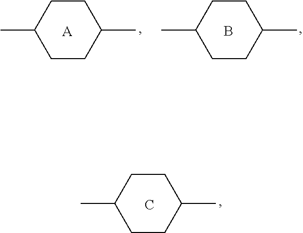

and

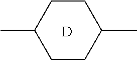

are the X group.

Each of the

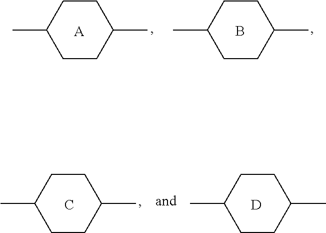

are one of phenyl, phenyl including one or more of hydrogen atoms substituted by F, Cl, Br, I, —CN, —NO2, or —C(═O)H, and cycloalkyl.

In this embodiment, the X group is one of 1,4-phenylene, 2,6-phenylene, and 1,4-cyclohexylene.

In this embodiment, one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers.

The main polymerization monomer is present in the liquid crystal material in a mass fraction of 0.2% to 1%, and the branching polymerization monomers are present in the liquid crystal material in a mass fraction of 0.03% to 0.05%.

For example, in this embodiment, the first-type polymerizable monomer is the main polymerized monomer, and the second-type polymerizable monomer and the third-type polymerizable monomer are the branching polymerizable monomers. In the liquid crystal material according to an embodiment, the first-type polymerizable monomer is present in the liquid crystal material in a mass fraction of 0.2% to 1%, and the second-type polymerizable monomer and the third-type polymerizable monomer are present in the liquid crystal material in a mass fraction of 0.03% to 0.05%.

In the above embodiments, a number of types of polymerizable monomers may be more than three, which are not specifically limited in the present application.

In this embodiment, because the first-type polymerizable monomers, the second-type polymerizable monomers, and the third-type polymerizable monomers have similar structures, they have approximately the same polymerization rate at different temperatures. In addition, their pretilt angles for deflection of the liquid crystal molecules are also approximately the same, which are within tolerance of errors, thereby eliminating the technical problem of non-uniformity in panel display and improving the display effect of the product.

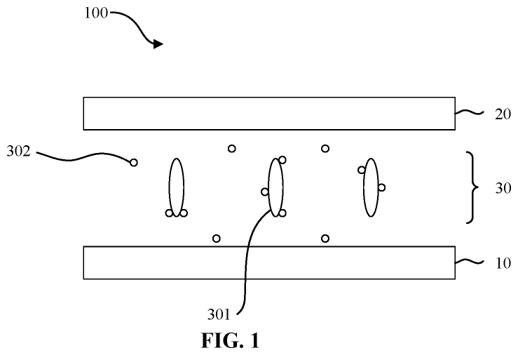

Referring to FIG. 1, the present application further provides a liquid crystal display panel 100 including a color filter substrate 20, an array substrate 10, and a liquid crystal layer 30 located between the color filter substrate 20 and the array substrate 10.

In this embodiment, the liquid crystal layer 30 includes liquid crystal molecules 301 and at least two types of polymerizable monomers 302;

In this embodiment, the polymerizable monomers 302 include at least a first-type polymerizable monomer, a second-type polymerizable monomer, and a third-type polymerizable monomer.

In this embodiment, the first-type polymerizable monomer has a structural formula of:

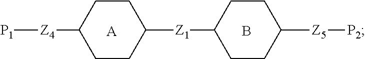

the second-type of polymerizable monomer has a structural formula of:

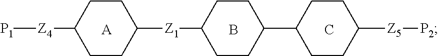

and

the third-type of polymerizable monomer has a structural formula of:

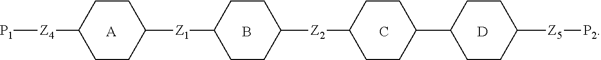

In this embodiment, the P1 group and the P2 group are the P group.

Each of the P1 group and the P2 group is selected from one of methacrylate, acrylate, vinyl, vinyloxy, and epoxy.

In this embodiment, the Z1 group, the Z2 group, the Z4 group, and the Z5 group are the Z group, the Z1 group, the Z2 group, the Z4 group, and the Z5 group are —(CH2)n- groups, or —(CH2)n- groups including one or more of the —CH2- substituted by one or more of —O—, —S—, —CO—, —CO—O—, —O—CO—, —O—CO—O—, —OCH2-, —CH2O—, —CH═CH—, —CF═CF—, —C≡C—, —CH═CH—COO—, and —OCO—CH═CH—.

In this embodiment,

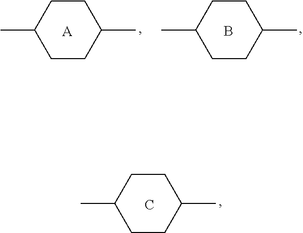

and

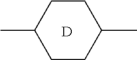

are the X group.

Each of the

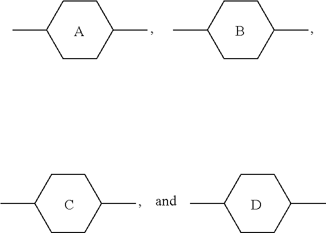

are one of phenyl, phenyl including one or more of hydrogen atoms substituted by F, Cl, Br, I, —CN, —NO2, or —C(═O)H, and cycloalkyl.

In this embodiment, the X group is one of 1,4-phenylene, 2,6-phenylene, and 1,4-cyclohexylene.

In this embodiment, one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers.

The main polymerization monomer is present in the liquid crystal material in a mass fraction of 0.2% to 1%, and the branching polymerization monomers are present in the liquid crystal material in a mass fraction of 0.03% to 0.05%.

In this embodiment, a distance between the color filter substrate and the array substrate is 3.2 μm to 3.5 μm.

In this embodiment, the alignment of the liquid crystal layer 30 needs to be irradiated with ultraviolet light twice. First, after a cell forming process is completed, a first ultraviolet irradiation is applied to the liquid crystal display panel 100 to cause the polymerizable monomers 302 to polymerize, and the transparent electrodes in the color film substrate 20 and the array substrate 10 are applied with a voltage to deflect the liquid crystal molecules, which thus have a certain pretilt angle. Secondly, the transparent electrodes in the color filter substrate 20 and the array substrate 10 are turned off, and then a second ultraviolet irradiation is applied to the polymerizable monomers 302, so that the polymerizable monomers 302 react completely.

In the above embodiments, a number of types of polymerizable monomers may be more than three, which are not specifically limited in the present application.

The present application also proposes a display device including the above-mentioned liquid crystal display panel and a backlight module. The working principle of the display device is the same as or similar to the above-mentioned liquid crystal display panel, and details are not repeated herein for brevity.

The present application proposes a liquid crystal material and a liquid crystal display panel. The liquid crystal material includes liquid crystal molecules and at least two types of polymerizable monomers; wherein each of the polymerizable monomers has a structural formula including at least one P group, at least one Z group, and at least one X group, the P group is located on opposite sides of each of the polymerizable monomers, and at least one side of the Z group is connected to the X group. The present application adopts at least two types of polymerizable monomers with different structural formulas, one type of the polymerizable monomers is a main polymerizable monomer, and the remaining polymerizable monomers are branching polymerization monomers, so that various types of polymerizable monomers in the present application have polymerization rates at different temperatures and pretilt angles for deflection which are within tolerance of errors, thereby improving the display effect of the product.

It can be understood that for a person of ordinary skill in the art, equivalent replacements or changes can be made according to the technical solution of the present application and its inventive concept, and all these changes or replacements should fall within the protection scope of the claims attached to the present application.

What is claimed is:

1. A liquid crystal material, comprising liquid crystal molecules and at least two types of polymerizable monomers;
wherein each of the polymerizable monomers has a structural formula comprising at least one P group, at least one Z group, and at least one X group, the P group is located on opposite sides of each of the polymerizable monomers, and at least one side of the Z group is connected to the X group.

2. The liquid crystal material according to claim 1, wherein the polymerizable monomers comprise at least a first-type polymerizable monomer, a second-type polymerizable monomer, and a third-type polymerizable monomer;
the first-type polymerizable monomer has a structural formula of: 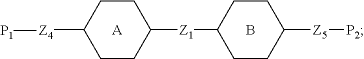
the second-type of polymerizable monomer has a structural formula of: 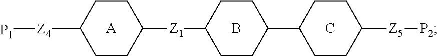
and
the third-type of polymerizable monomer has a structural formula of:

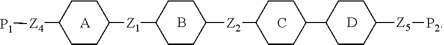

3. The liquid crystal material according to claim 2, wherein
the P1 group and the P2 group are the P group, and each of the P1 group and the P2 group is selected from one of methacrylate, acrylate, vinyl, vinyloxy, and epoxy;
the Z1 group, the Z2 group, the Z4 group, and the Z5 group are the Z group, the Z1 group, the Z2 group, the Z4 group, and the Z5 group are —(CH2)n- groups, or —(CH2)n- groups comprising one or more of the —CH2- substituted by one or more of —O—, —S—, —CO—, —CO—O—, —O—CO—, —O—CO—O—, —OCH2-, —CH2O—, —CH═CH—, —CF═CF—, —CH═CH—COO—, and —OCO—CH═CH—; and 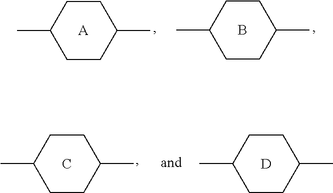
are the X group, and each of the 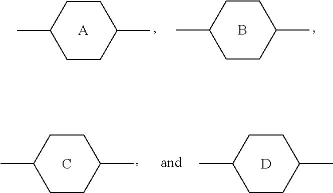
are one of phenyl, phenyl comprising one or more of hydrogen atoms substituted by F, Cl, Br, I, —CN, —NO2, or —C(═O)H, and cycloalkyl.

4. The liquid crystal material according to claim 3, wherein
the X group is one of 1,4-phenylene, 2,6-phenylene, and 1,4-cyclohexylene.

5. The liquid crystal material according to claim 2, wherein one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and
the main polymerization monomer is present in the liquid crystal material in a mass fraction of 0.2% to 1%, and the branching polymerization monomers are present in the liquid crystal material in a mass fraction of 0.03% to 0.05%.

6. A liquid crystal display panel, comprising a color filter substrate, an array substrate, and a liquid crystal layer disposed between the color filter substrate and the array substrate, wherein
the liquid crystal layer comprises liquid crystal molecules and at least two types of polymerizable monomers; and
each of the polymerizable monomers has a structural formula comprising at least one P group, at least one Z group, and at least one X group, the P group is located on opposite sides of each of the polymerizable monomers, and at least one side of the Z group is connected to the X group.

7. The liquid crystal display panel according to claim 6, wherein the polymerizable monomers comprise at least a first-type polymerizable monomer, a second-type polymerizable monomer, and a third-type polymerizable monomer;
the first-type polymerizable monomer has a structural formula of: 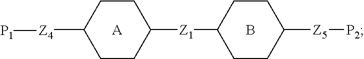
the second-type of polymerizable monomer has a structural formula of: 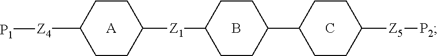
and
the third-type of polymerizable monomer has a structural formula of:

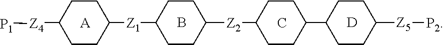

8. The liquid crystal display panel according to claim 7, wherein
the P1 group and the P2 group are the P group, and each of the P1 group and the P2 group is selected from one of methacrylate, acrylate, vinyl, vinyloxy, and epoxy;
the Z1 group, the Z2 group, the Z4 group, and the Z5 group are the Z group, the Z1 group, the Z2 group, the Z4 group, and the Z5 group are —(CH2)n- groups, or —(CH2)n- groups comprising one or more of the —CH2- substituted by one or more of —O—, —S—, —CO—, —CO—O—, —O—CO—, —O—CO—O—, —OCH2-, —CH2O—, —CH═CH—, —CF═CF—, —CH═CH—COO—, and —OCO—CH═CH—; and 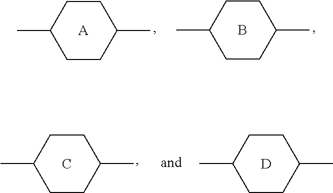
are the X group, and each of the 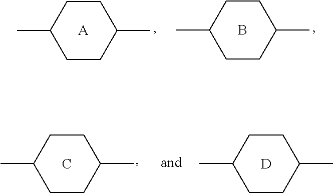
are one of phenyl, phenyl comprising one or more of hydrogen atoms substituted by F, Cl, Br, I, —CN, —NO2, or —C(═O)H, and cycloalkyl.

9. The liquid crystal display panel according to claim 7, wherein one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and
the main polymerization monomer is present in the liquid crystal material in a mass fraction of 0.2% to 1%, and the branching polymerization monomers are present in the liquid crystal material in a mass fraction of 0.03% to 0.05%.

10. The liquid crystal display panel according to claim 6, wherein a distance between the color filter substrate and the array substrate is 3.2 μm to 3.5 μm.

11. The liquid crystal display panel according to claim 6, wherein the X group is one of 1,4-phenylene, 2,6-phenylene, and 1,4-cyclohexylene.

12. A display device, comprising a backlight module and a liquid crystal display panel located on the backlight module, wherein the liquid crystal display panel comprises a color filter substrate, an array substrate, and a liquid crystal layer disposed between a color filter substrate and the array substrate;
the liquid crystal layer comprises liquid crystal molecules and at least two types of polymerizable monomers; and
each of the polymerizable monomers has a structural formula comprising at least one P group, at least one Z group, and at least one X group, the P group is located on opposite sides of each of the polymerizable monomers, and at least one side of the Z group is connected to the X group.

13. The display device according to claim 12, wherein the polymerizable monomers comprise at least a first-type polymerizable monomer, a second-type polymerizable monomer, and a third-type polymerizable monomer;
the first-type polymerizable monomer has a structural formula of: 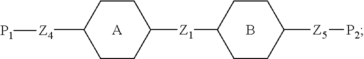
the second-type of polymerizable monomer has a structural formula of: 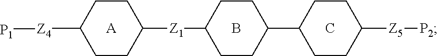
and
the third-type of polymerizable monomer has a structural formula of:

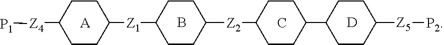

14. The display device according to claim 13, wherein
the P1 group and the P2 group are the P group, and each of the P1 group and the P2 group is selected from one of methacrylate, acrylate, vinyl, vinyloxy, and epoxy;
the Z1 group, the Z2 group, the Z4 group, and the Z5 group are the Z group, the Z1 group, the Z2 group, the Z4 group, and the Z5 group are —(CH2)n- groups, or —(CH2)n- groups comprising one or more of the —CH2- substituted by one or more of —O—, —S—, —CO—, —CO—O—, —O—CO—, —O—CO—O—, —OCH2-, —CH2O—, —CH═CH—, —CF═CF—, —CH═CH—COO—, and —OCO—CH═CH—; and 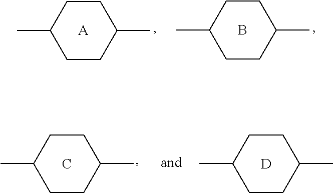
are the X group, and each of the 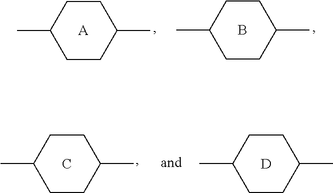
are one of phenyl,
phenyl comprising one or more of hydrogen atoms substituted by F, Cl, Br, I, —CN, —NO2, or —C(═O)H, and cycloalkyl.

15. The display device according to claim 13, wherein one of the first-type polymerizable monomer, the second-type polymerizable monomer, and the third-type polymerizable monomer is a main polymerization monomer, and polymerizable monomers other than the main polymerizable monomer in the first-type polymerizable monomer, the second-type polymerizable monomer, and the third-type polymerizable monomer are branching polymerization monomers; and
the main polymerization monomer is present in the liquid crystal material in a mass fraction of 0.2% to 1%, and the branching polymerization monomers are present in the liquid crystal material in a mass fraction of 0.03% to 0.05%.

16. The display device according to claim 12, wherein
a distance between the color filter substrate and the array substrate is 3.2 μm to 3.5 μm.

17. The display device according to claim 12, wherein
the X group is one of 1,4-phenylene, 2,6-phenylene, and 1,4-cyclohexylene.
